(19) United States
(12) Patent Application Publication
(10) Pub. No.: US 2017/0237318 A1
(43) Pub. Date: Aug. 17, 2017

(54) Device And Method For Cooling An Energy Conversion Apparatus Having A Rotor And At Least One Turbine

(71) Applicant: Siemens Aktiengesellschaft, Muenchen (DE)

(72) Inventors: Tabea Arndt, Erlangen (DE); Anne Bauer, Fuerth (DE); Michael Frank, Uttenreuth (DE); Jörn Grundmann, Grossenseebach (DE); Peter Kummeth, Herzogenaurach (DE); Wolfgang Nick, Nuernberg (DE); Marijn Peter Oomen, Erlangen (DE); Peter van Hasselt, Erlangen (DE)

(73) Assignee: Siemens Aktiengesellschaft, Muenchen (DE)

(21) Appl. No.: 15/502,010

(22) PCT Filed: Jul. 28, 2015
(86) PCT No.: PCT/EP2015/067202

§ 371 Date: Feb. 6, 2017

(30) Foreign Application Priority Data
Aug. 7, 2014 (DE) 102014215645.9

(51) Int. Cl. H02K 9/20; H02K 7/18; H02K 55/04; H02K 1/32

(52) U.S. Cl. CPC H02K 9/20; H02K 1/32; H02K 7/1823; H02K 55/04

(57) ABSTRACT

The present disclosure relates to a cooling systems. The teachings thereof may be embodied in apparati for cooling an energy conversion apparatus having an electric machine comprising a rotor rotating around a central shaft and at least one first turbine arranged on the same shaft. The cooling apparatus may include at least one first internal cavity of the shaft for transporting coolant into a region within the rotor. The first internal cavity may extend axially through the first turbine and through an axial intermediate space between the first turbine and rotor.

### CROSS-REFERENCE TO RELATED APPLICATIONS

This application is a U.S. National Stage Application of International Application No. PCT/EP2015/067202 filed Jun. 28, 2015, which designates the United States of America, and claims priority to DE Application No. 10 2014 215 645.9 filed Aug. 7, 2014, the contents of which are hereby incorporated by reference in their entirety.

### TECHNICAL FIELD

The present disclosure relates to a cooling systems. The teachings thereof may be embodied in apparati for cooling an energy conversion apparatus having an electric machine comprising a rotor with an axis of rotation and arranged on a rotating central shaft.

### BACKGROUND

The prior art has disclosed energy conversion apparati equipped with cooling apparati for the cooling rotating electrical coil windings. In particular, electric machines with superconducting rotor windings are typically equipped with cooling apparati with a coolant such as liquid nitrogen, liquid helium, or liquid neon circulating in the interior of a central shaft. The circulation comports with the thermosiphon principle and, in this way, dissipates heat from the rotor. By way of such cooling systems, it is possible for superconducting coil windings, in particular superconducting rotating exciter coils, to be cooled to an operating temperature below the transition temperature of the superconductor and kept at said operating temperature.

In known cooling apparatuses, an end region of the shaft assigned to the rotor of the electric machine is often used for feeding coolant, liquefied by a static refrigeration installation, into an interior space of the shaft, for example, via a static coolant pipe which projects into the shaft. A cooling apparatus of said type is known from EP2603968A1. It is not the case, however, in all energy conversion apparatuses that a free end of the shaft is available in the vicinity of the rotor for this purpose.

An example of such an arrangement of an electric machine is a generator in a gas and steam power plant. Here, it is desirable for both a generator and a gas turbine and a steam turbine to be arranged on the same rotating shaft. Here, the generator is may be arranged between the gas turbine and the steam turbine with only a short axial distance to be covered for the respective torque transmission by way of the shaft. In the case of such an arrangement, no free shaft end of the generator is available for the infeed of coolant.

In contrast, feeding coolant into a cavity of the rotor shaft in a central axial region of the shaft is generally associated with difficulties because, owing to the centrifugal forces that arise in the event of a rotation of the shaft, a coolant that is to be transported in the shaft is forced into radially outer regions. In the case of coolant being coupled radially into the shaft, it is however specifically necessary to realize an inflow of liquid coolant in a direction opposed to said centrifugal forces. Further difficulties lie in the reduction in mechanical robustness of the shaft at the shaft section configured for the infeed, and in the axial space requirement thereof, and in the thermal losses that arise during the infeed.

### SUMMARY

The present disclosure may enable a cooling apparatus for an energy conversion apparatus which avoids the stated disadvantages. In particular, teachings thereof may be embodied in cooling apparati in which a coolant can be coupled into a region of the shaft in the interior of the rotor of an electric machine of the apparatus in a simple manner.

For example, some embodiments may include a cooling apparatus (1) for cooling an energy conversion apparatus (2) having an electric machine (20) comprising a rotor (3) which is mounted so as to be rotatable about an axis of rotation (5) and which is arranged on a rotatable central shaft (7), and having at least one first turbine (23) which is arranged rotatably on the same shaft (7), comprising: at least one first internal cavity (9) of the shaft (7) for transporting coolant (13) into a region (11) within the rotor (3), wherein the first internal cavity (9) extends axially through the first turbine (23) and through an axial intermediate space (24) between the first turbine (23) and rotor (3).

In some embodiments, the shaft (7) has a first shaft end (8a) which is equipped with an apparatus (17) for feeding coolant (13) into the first internal cavity (9), wherein the first shaft end (8a) is arranged axially on a side of the first turbine (23) averted from the rotor (3).

In some embodiments, the first shaft end (8a) is additionally equipped with an apparatus (18) for conducting coolant (13) out of the first internal cavity (9).

In some embodiments, a second shaft end (8b) is situated axially opposite the first shaft end (8a) and is equipped with an apparatus (18) for conducting coolant out of an interior space of the shaft (7).

In some embodiments, the shaft (7) has, in the interior of the rotor (3), a heat transfer region (28) in which the coolant(13) is thermally coupled to at least one component to be cooled (33) which is arranged on the rotor (3).

In some embodiments, the shaft (7) has, in the interior of the rotor (3), a region (15, 29) for a thermodynamic change of state of the coolant (13) to take place in.

In some embodiments, the shaft (7), in its interior, has a throttle element (30) and has a second internal cavity (10) which is fluidically connected by way of the throttle element (30) to the first internal cavity (9).

In some embodiments, the shaft (7) has an evaporator region (15) in the interior of the rotor (3).

Some embodiments may include a thermal coupling device (37) for the cooling of a further component (39) of the energy conversion apparatus (2) outside the rotor (3) by way of thermal coupling to the coolant (13) transported in the interior of the shaft (7).

Some embodiments may include a cooling apparatus (1) which has a static refrigeration machine (41) for the cooling and/or compression of coolant (13) which is to be fed into the first internal cavity (9).

Some embodiments may include an energy conversion apparatus (2) having an electric machine (20) comprising a rotor (3) which is mounted so as to be rotatable about an axis of rotation (5) and which is arranged on a rotatable central shaft (7), having at least one first turbine (23) which is arranged rotatably on the same shaft (7), and having a cooling apparatus (1) as described above.

Some embodiments may include a second turbine (25) which is arranged rotatably on the same shaft (7), wherein the rotor (3) is arranged between first turbine (23) and second turbine (25).

Some embodiments may include a method for cooling an energy conversion apparatus (2) having an electric machine (20), comprising a rotor (3) which is mounted so as to be rotatable about an axis of rotation (5) and which is arranged on a rotatable central shaft (7), and having at least one first turbine (23) which is arranged rotatably on the same shaft (7), which method comprises at least the following step: transporting coolant (13) into a region (11) within the rotor (3) through a first internal cavity (9) of the shaft (7), which first internal cavity extends axially through the first turbine (23) and through an intermediate space (24) arranged between the first turbine (23) and rotor (3).

In some embodiments, the coolant (13) is fed as gaseous coolant (13b) into the first internal cavity (9) at elevated pressure and is subsequently expanded, in the interior of the rotor (3), through a throttle element (30) to a relatively low pressure, wherein the coolant (13) cools.

In some embodiments, the coolant (13) is fed as liquid coolant into the first internal cavity (9) and subsequently evaporates in an evaporator region (15) of the first internal cavity (9).

### BRIEF DESCRIPTION OF THE DRAWINGS

Various embodiments will be described below on the basis of a number of preferred exemplary embodiments with reference to the appended drawings, in which:

FIG. 1 shows a schematic longitudinal section through an energy conversion apparatus of a gas and steam power plant, according to teachings of the present disclosure;

FIG. 2 shows a schematic longitudinal section through a cooling apparatus, according to teachings of the present disclosure;

FIG. 3 shows a schematic longitudinal section through a cooling apparatus according to teachings of the present disclosure;

FIG. 4 shows a schematic longitudinal section through a cooling apparatus according to teachings of the present disclosure; and

FIG. 5 shows a schematic longitudinal section through a cooling apparatus according to teachings of the present disclosure.

### DETAILED DESCRIPTION

Various cooling apparati embodying the teachings of the present disclosure may serve to cool an energy conversion apparatus having an electric machine comprising a rotor which is mounted so as to be rotatable about an axis of rotation and which is arranged on a rotatable central shaft. The energy conversion apparatus may furthermore have at least one first turbine arranged rotatably on the same shaft. The cooling apparatus may comprise at least one first internal cavity of the shaft for transporting coolant into a region within the rotor of the electric machine, wherein the first internal cavity extends axially through the first turbine and through an axial intermediate space between the first turbine and rotor.

Here, the electric machine of the energy conversion apparatus can be operated either as a generator or as a motor. During operation as a generator, the entire energy conversion apparatus serves for converting mechanical energy into electrical energy. During operation as a motor, electrical energy is converted into mechanical energy. Aside from the electric machine, the energy conversion apparatus comprises a central shaft and at least one turbine, wherein the central shaft mechanically couples the rotor of the electric machine and the turbine and transmits torques between said components.

Here, in the text of the present disclosure, the word “rotor” is always to be understood to mean the rotor of the electric machine, by contrast to the rotating turbine, which in the technical field may also be referred to as a turbine rotor. In the present text, the word “turbine” is to be understood to mean only said rotatable turbine rotor, which may generally additionally be surrounded by a static outer housing.

Here, the word “shaft” is intended to designate the entire axially extending shaft of the energy conversion apparatus, regardless of whether said shaft is manufactured as a unipartite component or is assembled from different axial shaft segments. In general, however, torques can be transmitted over the length of the shaft, that is to say the shaft acts mechanically as one part. The shaft may for example be assembled from segments in the region of the rotor and in the region of the at least one turbine, and may comprise a rotor shaft and one or more turbine shafts coupled thereto. In these cases, too, the word “shaft” designates the entire mechanically connected arrangement composed of such axial segments.

Various embodiments of the cooling apparati disclosed herein provide that coolant can be easily conducted into the interior of the rotor through the first internal cavity, without a free shaft end of the electric machine being required for this purpose. Instead, the coolant is conducted in the first internal cavity through the interior of the first turbine. It is therefore not necessary for an infeed into the interior of the shaft to be provided in the immediate vicinity of the rotor, it rather being possible, for example, for said infeed into the interior of the shaft to be provided at a shaft end which is further remote.

Alternatively or in addition to an infeed at such a shaft end which is situated further remote, it is also possible for an indirect transfer of heat from the coolant to the external surroundings to take place at said shaft end which is further remote. Here, complex apparatuses for an infeed of coolant or for indirect heat transfer in an axially internally situated region of the shaft are advantageously avoided.

The described solution is associated with the requirement that a transfer of heat from the turbine to the coolant in the interior of the shaft which bears the turbine be kept so low that adequate cooling of the rotor components to be cooled can nevertheless be realized by way of the coolant.

In some embodiments, the first internal cavity in the shaft extends over the entire axial length of the turbine and furthermore over the entire axial length of the intermediate space between turbine and rotor. Said internal cavity may also extend over at least a part of the axial length of the rotor, such that coolant can pass by the first internal cavity into the interior thereof. It is thus possible for coolant to be introduced into the interior of the rotor through the first turbine. This reduces the total axial space requirement for a rotor situated between a turbine and, for example, a further component arranged on the shaft. No additional axial section is required for the coupling-in of coolant or for the indirect transfer of heat between rotor and turbine, such that the rotor can be arranged in a highly space-saving manner between the turbine and a further component, for example also between two turbines.

The transmission of a torque by the shaft between rotor and the first turbine can be ensured despite the elongated first internal cavity, because, for said transmission of torque, it is primarily the mechanical strength of an external shell of the shaft that is of significance. Therefore, it is also possible for that part of the shaft which bears the turbine to be in the form of a hollow shaft. The shaft mechanically couples the turbine and rotor and thereby effects a synchronous rotation of said two components about the common axis of rotation.

The energy conversion apparatus may include an electric machine with a rotor mounted to rotate about an axis of rotation and arranged on a central shaft, and at least one first turbine. The energy conversion apparatus may comprise a cooling apparatus as described herein.

The dissipation of heat by way of the coolant in the first internal cavity may be combined with further paths for heat dissipation, for example with a further radial and/or axial heat transport path in the interior of the rotor, by which components to be cooled which are arranged on the rotor can be thermally coupled to the coolant in the interior of the shaft. The electric machine may have an electric coil winding arranged on the rotor and cooled by way of the cooling apparatus. Said coil winding may be a superconducting coil winding, in particular a high-temperature superconducting coil winding. The electric machine can for example be operated either as a generator or as a motor.

Various methods incorporating the teachings of the present disclosure may serve for the cooling of an energy conversion apparatus having an electric machine comprising a rotor which rotates about an axis of rotation on a rotatable central shaft, and having at least one first turbine which is arranged rotatably on the same shaft. In some embodiments, a method comprises at least the step of transporting coolant into a region within the rotor through a first internal cavity of the shaft, which first internal cavity extends axially through the first turbine and through an intermediate space arranged between the first turbine and rotor. In particular, the coolant may be transported through the shaft into the interior of the rotor from a side of the turbine axially averted from the rotor.

The features of the cooling apparatus, of the energy conversion apparatus, and of the cooling method may be combined with one another. The shaft may have a first shaft end which is equipped with an apparatus for feeding coolant into the first internal cavity, wherein the first shaft end is arranged axially on a side of the first turbine averted from the rotor. In other words, by way of an infeed apparatus of said type, coolant can be introduced into the interior of the shaft from a shaft end which is situated behind the turbine as viewed from the rotor. In particular, during operation of the energy conversion apparatus, new coolant may be fed in constantly via said outer shaft end, such that a continuous transfer of heat from the rotor components from which heat is to be dissipated to the constantly inflowing fresh coolant is possible. The heat transfer from the rotor components to the external surroundings may, for example, take place via a closed coolant circuit, wherein an infeed of the coolant from the static system to the rotating system takes place at the first shaft end.

The first shaft end may comprise an apparatus for discharging coolant from the first internal cavity. In such embodiments, the infeed and the discharge of coolant may take place at the same axial end, which is not directly adjacent to the rotor, of the shaft. In such embodiments, only one side of the shaft which leads to the rotor needs to be in the form of a hollow shaft. A further part of the shaft, which is averted from the first turbine, may be in the form of a solid shaft.

Between the first shaft end and the rotor, the coolant may flow for example toward the rotor and away from the rotor in a common internally situated pipe. In the case of this particularly simple embodiment, the first internal cavity would be suitable for both transport directions. For example, coolant may circulate in both directions simultaneously in the manner of a thermosiphon or heatpipe.

In some embodiments, two internal cavities may extend between the first shaft end and the rotor. Here, a first and a second internal cavity may be led axially adjacent to one another in the interior of the shaft. Alternatively, one of the two cavities may concentrically surround the other. Here, the first internal cavity for the supply of coolant may be surrounded by a second internal cavity for the return of coolant. It is also possible for a reversed arrangement to be provided.

The cooling apparatus may have a second shaft end axially opposite the first shaft end and equipped with an apparatus for conducting coolant out of an interior space of the shaft. In such embodiments, coolant is thus conducted in and out again at axially oppositely situated shaft ends. For this purpose, the shaft may be in the form of a hollow shaft over its entire axial length. The cross section of the respective cavities may be selected smaller for a given shaft section in relation to the overall cross section of the shaft, because the individual cavities in each case only need to be dimensioned for transporting coolant in one direction, and it is not necessary for multiple pipes to be led parallel to one another or coaxially with respect to one another.

In embodiments of the energy conversion apparatus with a rotor arranged between two turbines on a common shaft, the coolant may then be conducted in through the interior of the first turbine and conducted out through the interior of the second turbine. Here, the first internal cavity may extend over the interior of both turbines, or the first internal cavity in the interior of the first turbine may be fluidically connected to a second internal cavity in the interior of the second turbine, such that a fluid coolant can be transported between the two internal cavities. Said two cavities may for example be fluidically connected to one another in the interior of the rotor. In such embodiments, a thermodynamic change of state may take place at the transition between the two internal cavities.

In some embodiments, coolant that emerges from the shaft may be recirculated, in the manner of a closed circuit, from the discharge apparatus to an infeed apparatus of the shaft again. The coolant may comprise helium, neon, and/or nitrogen. Here, the coolant may generally be present in the form of a gaseous coolant, in the form of a liquid coolant, or in the form of a coolant which changes between these two states within the cooling circuit.

The first internal cavity and/or the second internal cavity may be thermally insulated with respect to the surrounding shell of the shaft. Thermal insulation of the heatpipe with respect to the radially outer regions of the shaft may include a vacuum insulation. Alternatively or additionally, some embodiments may include a material which exhibits poor thermal conductivity and/or a material which reflects radiation arranged between the outer wall of the internal cavity and an outer shell of the shaft. For example, a multi-layer thermal insulation composed of reflective metal foils may be used. In general, by way of such insulation, unnecessary introduction of heat into the coolant in the interior of the shaft is reduced, which contributes to improved cooling of the components arranged on the rotor. In particular, heating of the coolant in the interior of the first turbine with a typically relatively high operating temperature of the turbine can be reduced.

The shaft may include, in the interior of the rotor, a heat transfer region in which the coolant is thermally coupled to at least one component to be cooled which is arranged on the rotor. Said further thermal connection in the heat transfer region of the shaft may for example be realized by virtue of the coolant being conducted through ducts in regions situated radially further to the outside. Alternatively, said further thermal connection may also be realized by way of a heatpipe which is independent of the fluid but which is coupled on in a thermally conductive manner and which has a further coolant. Alternatively, the further connection may be realized by way of conduction of heat in materials which exhibit good thermal conductivity.

In various embodiments, radial transport of heat toward the interior of the shaft from rotor regions situated radially further to the outside may occur, and/or a combination of axial and radial heat transport may occur in the interior of the rotor. The heat transfer region may include a region of the first internal cavity of the shaft, and/or may be arranged in a further internal cavity of the shaft fluidically coupled to the first internal cavity.

The shaft may have, in the interior of the rotor, a region for a thermodynamic change of state of the coolant to take place in. Said thermodynamic change of state may for example lead either to heat being transferred from a part of the rotor to the coolant in the interior of the shaft, or else the change of state may firstly lead to cooling of the coolant in the interior of the shaft before heat is transferred from parts of the rotor to the coolant.

For example, the shaft, in its interior, may have a throttle element and may have a second internal cavity which is fluidically connected to the first internal cavity by way of the throttle element. The thermodynamic change of state is then the change in pressure of the gas during the expansion through the throttle element, and the associated temperature change. Such embodiments may reduce, prevent, or compensate for intense heating of the coolant on the path from the shaft end to the interior of the rotor.

Owing to the lengthened path of the coolant through the shaft in the interior of the turbine in relation to conventional solutions, heating of the coolant on the path to the interior of the rotor may occur more easily. Over at least a part of said path, the coolant is present at a temperature higher than the temperature at which the coolant is used in the rotor for cooling the components that are present there. This may be achieved by introducing the coolant as a gaseous coolant into the first internal cavity at elevated pressure and then expanding, in a second internal cavity, through a throttle element positioned downstream of the first cavity. A throttle element may include an expansion valve.

Owing to the Joule-Thompson effect, it is the case in real gases that, below the inversion temperature thereof, cooling of the gas occurs in the event of such a reduction in pressure. In such an embodiment, it is thus possible, by way of a pressure difference between the first and second internal cavities, to achieve that the gas reaches a low temperature required for the cooling of the rotor components for the first time in the second cavity. Owing to the relatively high temperature prevailing in the first internal cavity, the heating of the coolant during the axial transport thereof through the shaft may be reduced, because the temperature gradient between the coolant and the surrounding materials is smaller in said regions than in the region of the downstream second internal cavity.

In general, it is also possible for multiple throttle elements to be connected in series to cool the coolant down to a temperature required for the cooling within the rotor in multiple stages. For this purpose, it is then possible for multiple internal cavities to be positioned in series in the axial direction, and fluidically connected to one another by way of the individual throttle elements. This may provide stepped cooling on the axial path of the coolant from the first shaft end in the direction of the rotor. Said multiplicity of throttle elements may be arranged entirely in the interior of the rotor, and/or at least some of the throttle elements may be arranged in the intermediate space between rotor and turbine and/or even within the turbine. Such a series arrangement of multiple throttle elements may be suitable both for embodiments in which the coolant is conducted in and conducted out at the same shaft end and for embodiments in which the coolant is conducted in and conducted out at oppositely situated shaft ends.

Alternatively or in addition to the embodiment with a throttle element, the shaft may have an evaporator region in the interior of the rotor. For example, the first internal cavity may be in the form of a heatpipe in which coolant is transported in liquid form from the first shaft end in the direction of the rotor, wherein, in the evaporator region, the coolant evaporates, absorbing heat from the components of the rotor, and can finally pass as gaseous coolant back to the first shaft end. Here, the inward transport of liquid coolant and the return transport of gaseous coolant may be realized either in the same first internal cavity, or it is alternatively possible for different lines running axially in the interior of the shaft to be used for the inward transport and the return transport. For such embodiments, the coolant may be fed as liquid coolant into the interior of the shaft at the first shaft end. In some embodiments, gaseous coolant may be fed into the shaft at elevated pressure, and for the coolant, after expansion through a throttle element, to cool and, in the process, condense, wherein said liquefied coolant can evaporate in an evaporator region in the interior of the rotor, absorbing heat, and is subsequently conducted out of the shaft again as gaseous coolant. Here, the gaseous coolant may be conducted out at the same first shaft end, or the coolant may be transported onward, in a uniform axial direction, to the opposite second shaft end and coupled out of the interior of the shaft from there.

The cooling apparatus may have an additional thermal coupling device for the cooling of a further component of the energy conversion apparatus outside the rotor by way of thermal coupling to the coolant transported in the interior of the shaft. Said thermal coupling device may be positioned downstream of a heat transfer region in the interior of the rotor as viewed in a flow direction of the coolant. In other words, the coolant, downstream of the region in which it is in thermal contact with the rotor components to be cooled, may be used for further cooling of one or more components of the energy conversion apparatus. Said one or more components may include a shaft bearing. Said shaft bearing may for example be a bearing in the region of the first turbine, of the rotor or of a second turbine that may be provided. Multiple such shaft bearings may be cooled by way of an onward flow or return flow of coolant. For a downstream cooling step of said type, low temperatures of the coolant such as are used for the cooling of superconducting coil windings to an operating temperature of the superconductor are not required. Rather, in this embodiment, residual cooling potential of the already slightly heated coolant can be utilized to cool a component of the electric machine or of the turbines, in this example a shaft bearing, which heats up during operation. Alternatively or in addition, it is also possible for further components of the electric machine or of the turbines, which heat up intensely during operation, to be cooled by way of the outflowing coolant.

The cooling apparatus may have a static refrigeration machine for the cooling and/or compression of coolant which is to be fed into the first internal cavity. In such embodiments, the coolant may be circulated, in the form of a closed circuit, between an apparatus for feeding said coolant into the shaft and an apparatus for conducting said coolant out of the shaft. For example, a cold head of a refrigeration machine may serve for re-condensing that part of the coolant which is evaporated in an evaporator region in the interior of the rotor, wherein, at the same time, heat is transferred from the coolant to the cold head of the refrigeration machine. In such embodiments, a closed circuit may conduct liquid coolant introduced into the shaft and gaseous coolant that flows out of the shaft.

Alternatively, the refrigeration machine may include a compression-type refrigeration machine, and a compressor may be arranged in the coolant circuit. The compressor may compress a gaseous coolant flowing out of the shaft and—after a release of heat to the surroundings by way of a heat exchanger—recirculate said coolant to the infeed apparatus again under thus elevated pressure. Such an embodiment may be combined with a throttle element in the interior of the shaft, through which the compressed gaseous coolant can be expanded so as to cool.

The energy conversion apparatus may have a second turbine rotating on the same shaft. Here, the rotor may be arranged between the first and second turbines. Such an embodiment may be used in a gas and/or steam power plant, in which the rotor of a generator is arranged on a continuous shaft between a gas turbine and a steam turbine. The rotor, gas turbine, and steam turbine are mechanically coupled by way of the common shaft and the torques are transmitted between said components via the shaft.

The electric machine may have a superconducting coil winding with an operating temperature between 20 K and 100 K, in particular between 20 K and 77 K. Machines with superconducting coil windings in the rotors have, in relation to conventional machines, advantages with regard to efficiency, power density, and dynamics and flexibility. The machine may include a generator of a power plant. Said machine may be designed for a power range of 10 MW to 2 GW, in particular between 400 MW and 2 GW.

Some embodiments may include methods for cooling the energy conversion apparatus. In some embodiments, a thermodynamic change of state may take place in the interior of the shaft after the transport of coolant into the first internal cavity of the shaft. Said thermodynamic change of state may contribute to a transfer of heat from components of the rotor to the coolant and/or may contribute to cooling of the coolant in the interior of the rotor in order to subsequently realize a greater cooling action for the components to be cooled.

For example, the coolant may be fed as gaseous coolant into the first internal cavity at elevated pressure and subsequently expanded, in the interior of the rotor, through at least one throttle element to a relatively low pressure, wherein the coolant cools. Here, the elevated pressure is to be understood in the first instance to generally mean a pressure above atmospheric pressure.

The pressure at which the gaseous coolant is fed into the first internal cavity may in this case be above 1 bar, above 5 bar, and/or above 150 bar. Some coolants may comprise helium, neon, nitrogen, and/or hydrogen. The temperature of the gas that is introduced into the first internal cavity may lie above 250 K, wherein, after the expansion through the at least one throttle element in the interior of the rotor, a temperature of the coolant below 45 K can be achieved.

In some embodiments, the coolant may be fed as liquid coolant into the first internal cavity and subsequently evaporate in an evaporator region of the first internal cavity.

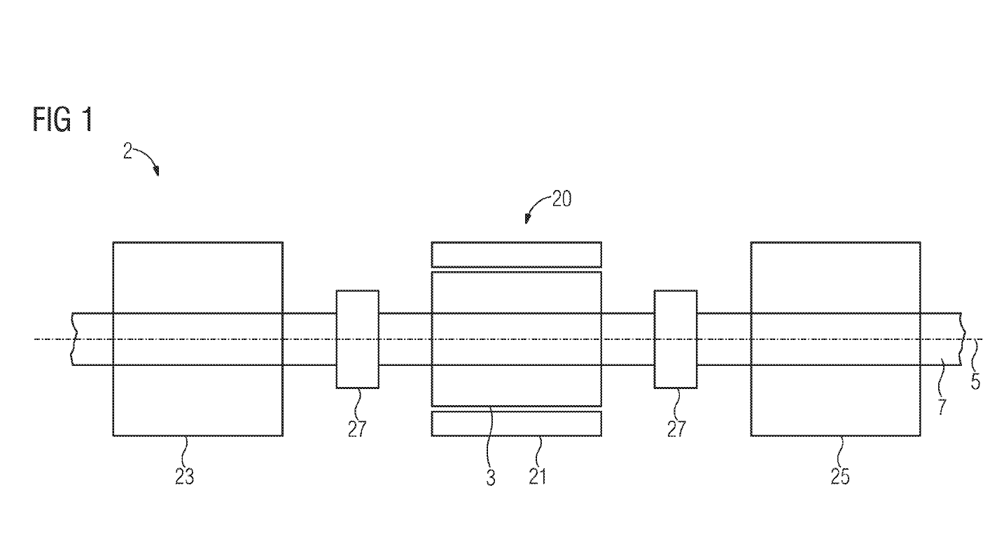

FIG. 1 shows a schematic longitudinal section through an energy conversion apparatus 2 of a gas and steam power plant according to teachings of the present disclosure. The energy conversion apparatus comprises a first turbine 23, which operates as a gas turbine, and a second turbine 25, which operates as a steam turbine. Between the two turbines 23 and 25 there is arranged an electric machine 20—in this case a generator—with an internally situated rotor 3 and with a stator 21 surrounding said rotor. The rotor 3 and the two turbines 23 and 25 adjacent thereto are arranged on a common shaft 7 to rotate about an axis of rotation 5. Here, the shaft 7 realizes the mechanical coupling between the rotating components and transmits the torques. By way of the arrangement on a common shaft 7, the two turbines 23 and 25 and the rotor 3 of the generator 20 can rotate synchronously.

In the example shown in FIG. 1, the shaft 7 is assembled from three sections which are in each case connected by way of flange couplings 27. It is however alternatively also possible for the shaft 7 to be manufactured from one single continuous component. The arrangement shown corresponds to a so-called single-shaft arrangement (single-shaft configuration) of a combined power plant in which both a gas turbine 23 and a steam turbine 25 are utilized for driving a rotor 3, and thus both turbines drive the same generator 20 via the same shaft 7. Here, combustion of a gas in the gas turbine generates mechanical power at the shaft, and a further part of the mechanical power is generated in the steam turbine.

For the generation of the steam required for this purpose, the hot exhaust gases from the gas turbine may for example be used in a waste-heat steam boiler for generating water vapor. The steam may be expanded in the steam turbine and thereby additionally output mechanical power to the shaft. The mechanical power at the shaft is converted, in the generator, into electrical power. The arrangement of the two turbines on a common shaft can lead to particularly efficient operation of the power plant and to a reduction of the required generator components. The embodiments of the cooling apparatus 1 described below may be used for example in combined gas and steam power plants of said type.

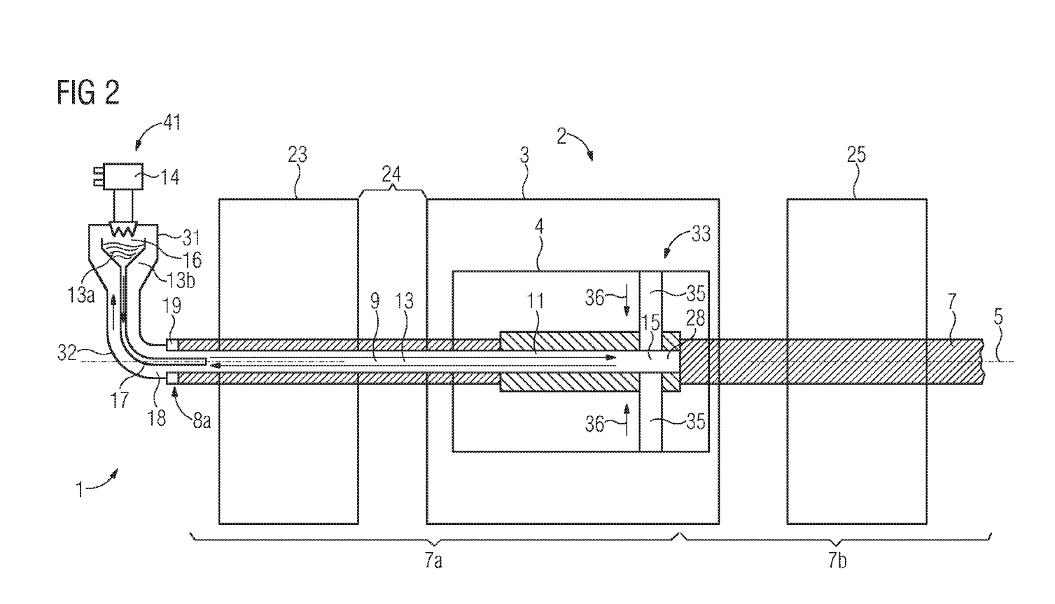

FIG. 2 shows a schematic longitudinal section through a cooling apparatus 1 according to teachings of the present disclosure. The figure shows, in turn, an energy conversion apparatus 2 having two turbines 23 and 25, between which a rotor 3 of a generator is arranged on a common shaft 7. The rotor has at least one component 33 to be cooled, which component is to be cooled by way of the cooling apparatus 1 of the energy conversion apparatus 2 and, in this example, is in the form of a superconducting coil winding 4. The coil winding 4 must thus, for efficient operation of the generator, be cooled down to an operating temperature in a cryogenic temperature range. For this purpose, cooling apparatus 1 comprises a static refrigeration installation 41 and a first internal cavity 9 arranged within the shaft 7. The shaft 7 is, in a first axial shaft section 7a, in the form of a hollow shaft, wherein said shaft section 7a extends from a first shaft end 8a through the first turbine 23 into the interior of the rotor 3. Via the first internal cavity 9, it is thus possible for coolant 13 to be conducted out of the static refrigeration installation 41 into the interior of the rotor 3 and, from there, to cool the superconducting coil winding 4. By contrast, in this example, a region 7b of the shaft 7 axially adjoining the first shaft section 7a is in the form of a solid shaft without an internal cavity.

In the embodiment shown, the first shaft end 8a is equipped with an apparatus 17 for feeding coolant 13 in. In this example, said apparatus is a static pipe which projects into the first internal cavity 9 at the first shaft end. In said pipe, liquid coolant 13a, in the present example liquefied neon, is conducted into the interior of the shaft from a condenser region 16 of the refrigeration machine 41. Said pipe may either continue as a static pipe in the interior of the rotating shaft, or may be coupled by way of a rotary seal to a rotating pipe part, or the liquid coolant 13a may flow axially in the direction of the rotor 3 in a relatively large cavity surrounding the pipe.

Said flow may for example be assisted by gravitational force, in particular if the coolant pipe continues in the interior of the shaft and is designed to slope downward slightly. Alternatively or in addition, the flow of the liquid coolant to the rotor may be assisted by capillary forces and/or, in the case of a conical shape of the internal cavity of the shaft, by way of centrifugal forces. In all these variants, the liquid coolant 13a passes through the internal cavity 9 of the shaft 7 into a region 11 in the interior of the rotor 3, including an evaporator region 15 in which an outer wall of the cavity 9 is thermally connected to the object 33 to be cooled or to those objects of the rotor 3 which are to be cooled.

In the example shown, said thermal connection includes heat-conducting elements 35 composed of material which exhibits good thermal conductivity, such that a heat flow 36 from the superconducting coil winding 4 in the direction of the evaporator region 15 of the internal cavity 9 is realized. There, the liquid coolant 13 evaporates, absorbing heat in the heat transfer region 28, and the gaseous coolant 13b that is formed can pass axially back in the direction of the first shaft end 8a through the same internal cavity 9.

In the region of the first shaft end 8a, the outer shell of the shaft 7 is connected by way of a rotary seal 19 to an outer pipe 32, such that the gaseous coolant 13b is conducted, in the outer pipe, to a cold head 14 of the static refrigeration machine 41, where said coolant condenses in a condenser region 16 and, in turn, in the manner of a closed circuit, can be conducted back into the apparatus 17 for feeding coolant 13 into the shaft 7. Altogether, that component 33 of the rotor 3 from which heat is to be dissipated is cooled by way of coolant 13 transported in the interior of the shaft 7, wherein the coolant is conducted axially through the first turbine 23. In the embodiment shown, the coolant is conducted in and conducted out again at the same first shaft end 8a. The internal cavity 9 of the shaft serves in this case as a heatpipe, in which both liquid coolant 13a is transported to the rotor 3 and gaseous coolant 13b is transported away from the rotor.

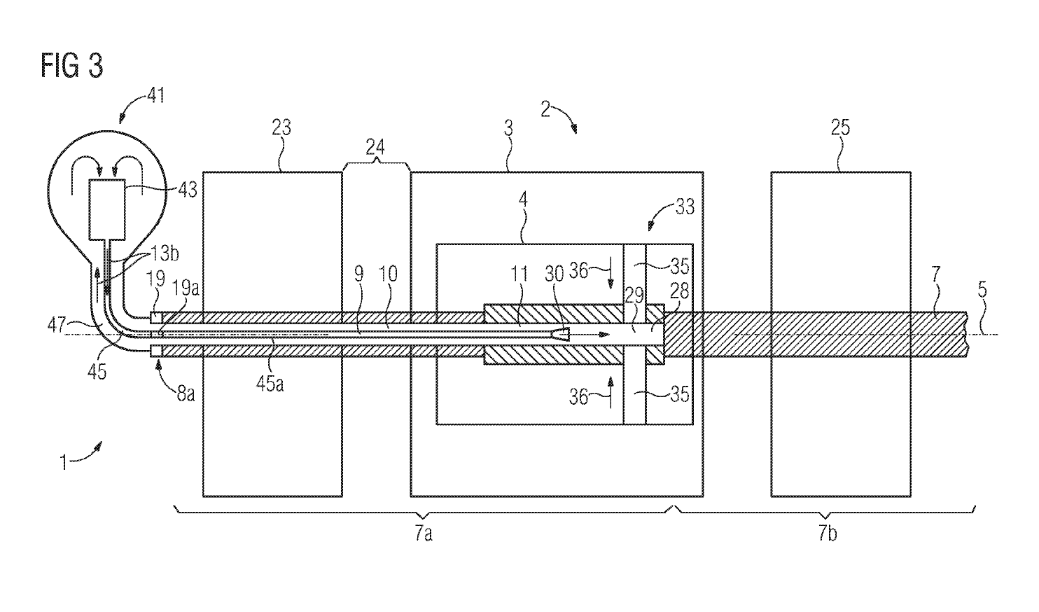

FIG. 3 shows a schematic longitudinal section through a cooling apparatus 1 according to teachings of the present disclosure. Components which correspond to components of FIG. 2 are generally denoted by the same reference designations, and are of analogous action to those in the figures described previously. Coolant 13 is fed in and conducted out again at the first shaft end 8a. It is also the case here that the shaft is, in a first shaft section 7a, in the form of a hollow shaft between said first shaft end 8a and the interior of the rotor, whereas said shaft is of solid form in an adjoining shaft section 7b. By contrast to the first example, however, the coolant 13 is introduced into the first shaft end not as a liquid coolant but as a gaseous coolant 13b at elevated pressure. The apparatus for the infeed of coolant is thus in this case in the form of a high-pressure line 45, wherein the static outer part of the high-pressure line 45 is, in the region of the first shaft end, connected by way of a pressure-tight rotary seal 19a to a rotating part, situated within the shaft 7, of the high-pressure line 45a.

Then, in the interior of the shaft 7, a first internal cavity 9 is realized by the interior of said rotatable continuation 45a of the high-pressure line. Gaseous compressed coolant 13b (e.g., neon) is conducted through said cavity 9 under pressure to a throttle element 30 arranged in the interior of the rotor 3. Through said throttle element 30, for example an expansion valve, the pressurized gas 13b is expanded into a second internal cavity 10. Here, the gaseous coolant cools to a temperature considerably lower than the temperature of the pressurized coolant in the first internal cavity 9. A heat transfer region 28 of the second internal cavity 10 is now in thermal contact with that component 33 of the rotor 3 which is to be cooled. In this example, too, said thermal contact includes heat-conducting elements 35.

In said region 28, the now expanded gaseous coolant 13b is heated and subsequently conducted axially back to the first shaft end 8a again through a continuation which surrounds the high-pressure pipe of the second internal cavity 10. Said illustrated coaxial arrangement of the two coolant lines 9 and 10 provides that the return flow of expanded gas, even after an exchange of heat in the heat transfer region 28, may still be at a lower temperature than the pressurized gas 13b, and can thus effect precooling of the inflowing gas in the manner of a heat exchanger. Furthermore, by way of the outflowing, already-expanded gas, direct thermal interaction between the pressurized gas and the possibly relatively warm outer shell of the shaft is reduced. Said outer shell may expediently, in this and in all other embodiments, be thermally insulated with respect to the internally situated coolant lines 9 and 10 by way of a vacuum insulation (not explicitly illustrated here) and/or some other type of thermal insulation.

The expanded gaseous coolant in the second internal cavity 10 passes, at the first shaft end 8a, via a rotary seal 19 back into an outer low-pressure line 47 of the cooling apparatus, which leads to a refrigeration machine 41 shown in FIG. 3. The refrigeration machine is in this example in the form of a compression-type refrigeration machine with a compressor. In the compressor, the expanded gas is compressed again, wherein the heat that is released during said compression is extracted from the gas again by way of further components (not shown here) of the refrigeration machine 41. From the compressor, the compressed gaseous coolant is in turn fed into the high-pressure line 45, and the coolant circuit is completed.

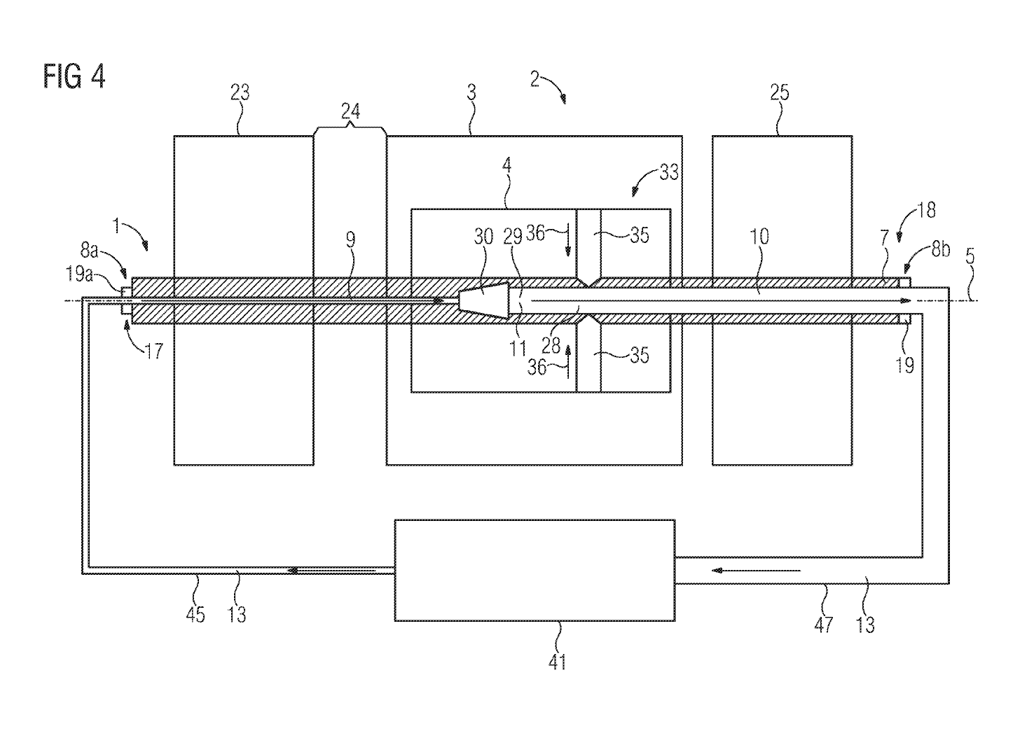

FIG. 4 shows a schematic longitudinal section through a cooling apparatus 1 according to teachings of the present disclosure. In this example, the shaft 7 is in the form of a hollow shaft over its entire axial length, wherein an apparatus 17 for feeding coolant 13 in is arranged at a first shaft end 8a, and an apparatus 18 for conducting coolant out is arranged at an oppositely situated second shaft end 8b. For this purpose, at the first shaft end 8a, a high-pressure line 45 is connected by way of a pressure-tight rotary seal 19a to a first internal cavity 9 of the shaft 7. Similarly, at the second shaft end 8b, a low-pressure line 47 is connected by way of a rotary seal 19 to a second internal cavity 10 of the shaft 7.

Between the low-pressure line 47 and the high-pressure line 45, there is in turn arranged a refrigeration machine 41 with a compressor, in which the gaseous coolant of the low-pressure line 47 is compressed to relatively high pressure and is then fed into the high-pressure line 45. In this case, too, a closed coolant circuit is formed by the lines and the compressor, wherein, in turn, heat is extracted from the gas in the region of the refrigeration machine 41, for example by way of a cooling body by way of which heat is transferred to the external surroundings.

Thus, by the first internal cavity 9, pressurized gas is conducted through the first turbine 23 into the interior of the rotor 3, where, in turn, the gas is expanded through a throttle element 30, wherein the gas simultaneously cools. In this case, too, the gas that is cooled in this way comes into thermal contact, in a heat transfer region 28, with one or more heat-conducting elements 35, which in turn are thermally coupled to that component 33 of the rotor 3 which is to be cooled. After the expansion, the gaseous coolant 13b is subsequently, in the axially adjoining region of the shaft 7, conducted in the second internal cavity 10 through the second turbine 25 and to the second shaft end 8b.

In this third embodiment, the expanded gas 10 which is heated slightly in the heat transfer region 28 but which is still cool cannot be used for precooling the inflowing pressurized gas. It may be used for cooling further components which adjoin the second internal cavity 10, as described in the following embodiment. In general, however, it is also possible for both internal cavities 9 and 10 to be thermally insulated with respect to the surrounding outer shell of the shaft, for example by way of a surrounding vacuum insulation or some other thermal insulation which is not shown in the figures for the sake of clarity. In an embodiment of said type, the coolant 13 serves only for cooling individual components 33 of the rotor 3, and the introduction of heat into the coolant 13 is kept altogether as low as possible.

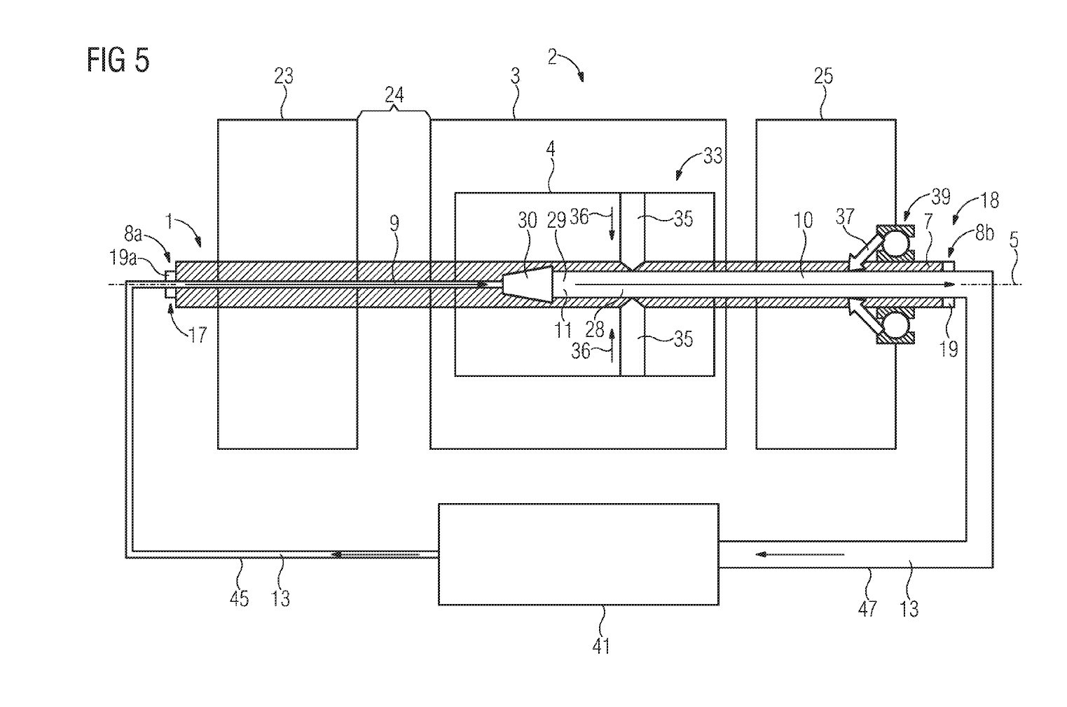

A fourth embodiment is shown schematically in FIG. 5. The flow of gaseous coolant 13 through the entire axial length of the shaft 7 and the expansion of pressurized gas in the interior of the rotor 3 are similar in this example to those in the third exemplary embodiment shown in FIG. 4. A difference however consists in the fact that, here, in the region of the second internal cavity 10, an additional thermal coupling device is arranged between an outer wall of said cavity 10 and a shaft bearing 39. In the example shown, said shaft bearing is a shaft bearing 39 in the region of the second turbine 25.

In general, shaft bearings of said type heat up during operation of the energy conversion apparatus, and the outflowing gas, which is still cold, can be utilized for additional cooling of such hot components. A similar form of shaft bearing cooling by way of coolant 13 flowing back to the refrigeration machine and/or even by way of coolant flowing in from the refrigeration machine is also possible as a variant of the other described embodiments. For example, it may be combined with a heatpipe for cooling rotor components over an evaporator region and/or in an embodiment in which coolant is conducted in and conducted out again on the same side of the shaft.

In some embodiments, including all of those depicted and described above, one or more internal cavities 9 and 10 of the shaft extend(s) over a relatively large part of the axial length thereof. Thus, at least one first cavity 9 extends through the first turbine 23 and into an internal region of the rotor 3. In some embodiments, the same cavity or a further cavity may also extend even further through the rotor 3 and through the second turbine to the oppositely situated shaft end.

The shaft 7 may generally be formed either with a continuous outer shell or may, similarly to that shown in FIG. 1, be assembled from multiple shaft sections. Flange couplings 27 with corresponding coolant seals may be used, which also connect the internally situated cavities 9 and 10 of the shaft 7 to one another in an axial direction. Alternatively, it is also possible for only segments of the outer shell of the shaft to be connected by way of flange couplings 27, whereas, in the interior of the shaft, a continuous pipe may extend over multiple sections.

What is claimed is:

1. A cooling apparatus for an electric machine comprising a rotor mounted to rotate about an axis of rotation on a rotatable central shaft, and at least one first turbine arranged on the same shaft, the cooling apparatus comprising:
at least one first internal cavity of the shaft for transporting coolant into a region within the rotor;
wherein the at least one first internal cavity extends axially through the first turbine and through an axial intermediate space between the first turbine and rotor.

2. The cooling apparatus as claimed in claim 1, wherein:
the shaft includes a first shaft end equipped with a coolant feeder for feeding coolant into the first internal cavity; and
wherein the first shaft end is arranged axially on a side of the first turbine averted from the rotor.

3. The cooling apparatus as claimed in claim 2, wherein the first shaft end includes an apparatus for conducting coolant out of the first internal cavity

4. The cooling apparatus as claimed in claim 2, further comprising a second shaft end situated axially opposite the first shaft end equipped with an apparatus for conducting coolant out of an interior space of the shaft.

5. The cooling apparatus as claimed in claim 1, wherein the shaft further comprises, in the interior of the rotor, a heat transfer region in which the coolant is thermally coupled to at least one component to be cooled arranged on the rotor.

6. The cooling apparatus as claimed in claim 1, wherein the shaft further comprises, in the interior of the rotor, a region for a thermodynamic change of state of the coolant to take place in.

7. The cooling apparatus as claimed in claim 6, wherein the shaft further comprises, in its interior, a throttle element and a second internal cavity fluidically connected by way of the throttle element to the first internal cavity.

8. The cooling apparatus as claimed in claims 6, wherein the shaft further comprises an evaporator region in the interior of the rotor.

9. The cooling apparatus as claimed in claim 1, further comprising a thermal coupling device for the cooling of a further component of the electric machine arranged outside the rotor by way of thermal coupling to the coolant transported in the interior of the shaft.

10. A cooling apparatus as claimed in claim 1, further comprising a static refrigeration machine for the cooling and/or compression of the coolant (13) to be fed into the first internal cavity.

11. An energy conversion apparatus comprising:
an electric machine with a rotor mounted to rotate about an axis of rotation and arranged on a rotatable central shaft,
at least one first turbine mounted on the shaft, and
at least one first internal cavity of the shaft for transporting coolant into a region within the rotor,
wherein the at least one first internal cavity extends axially through the first turbine and through an axial intermediate space between the first turbine and rotor.

12. The energy conversion apparatus as claimed in claim 11, further comprising a second turbine arranged rotatably on the same shaft, and wherein the rotor is arranged between first turbine and second turbine.

13. A method for cooling an electric machine comprising a rotor mounted to rotate about an axis of rotation on a rotatable central shaft and at least one first turbine rotates on the same shaft, the method comprising:
transporting coolant into a region within the rotor through a first internal cavity of the shaft,
wherein the first internal cavity extends axially through the first turbine and through an intermediate space arranged between the first turbine and rotor.

14. The method as claimed in claim 13, further comprising:
feeding a gaseous coolant into the first internal cavity at elevated pressure; and
subsequently expanding the coolant in the interior of the rotor through a throttle element to a lower pressure.

15. The method as claimed in claim 13, further comprising:
feeding a liquid coolant into the first internal cavity; and
subsequently evaporating the coolant in an evaporator region of the first internal cavity.
